(19) United States
(12) Patent Application Publication
(10) Pub. No.: US 2016/0295798 A1
(43) Pub. Date: Oct. 13, 2016

(54) Weed eater head

(71) Applicant: Marcus Ferguson, Hixson, TN (US)

(72) Inventor: Marcus Ferguson, Hixson, TN (US)

(21) Appl. No.: 14/545,211

(22) Filed: Apr. 8, 2015

(51) Int. Cl. A01D 34/416

(52) U.S. Cl. CPC A01D 34/4166

(57) ABSTRACT

A weed trimming attachment for trimming machines commonly known as “weed eaters.” The weed trimming attachment comprises a weed eater head preferably made of a heavy-duty plastic and molded in a single piece. Each weed eater head includes at least two and preferably three trimmer connection portions that are equidistantly spaced around the general circumference of the weed eater head. A quick connect means secures trimming material, whether weed eater line, blades, or other trimming material, to the weed eater head at the trimmer connection portions. The weed trimming attachment easily replaces the attachment that is provided with the weed eater.

### BACKGROUND

A typical weed eater includes a line dispenser attached to a rotating shaft at the base of the weed eater. The line dispenser of existing weed eaters usually includes a line holder wrapped with monofilament line that is dispensed through openings in the sidewalls of the line dispenser. The line dispenser includes a spring-loaded mechanism that allows the spool of line to unwind and thus dispense line through the openings. The spring holds tension on the spool until it is “bumped.” When the tension is released momentarily, the spool is allowed to rotate and the centrifugal force of the rotating head and line allows the line to unwind and automatically dispense.

However, when the spool is empty, the line must be rewound manually on the spool requiring disassembly of the line dispenser, rewinding of line on the spool, and reassembly of the line dispenser, sometimes with difficulty feeding the line back through the dispensing opening.

The present invention solves many of these difficulties with existing art by replacing the standard weed eater line dispenser with a rotating head that doesn't require a line spool, manual rewinding of line, a particular size or diameter of line, or difficult disassembly and reassembly to replace the trimmer line.

### SUMMARY

The present invention provides a new weed trimming attachment for a “weed eater.” The attachment of the present invention secures to the rotating shaft of the weed eater once the standard line dispenser is removed. The weed trimming attachment has a weed eater head that includes a central connection portion located at the rotational center of the weed eater head. Preferably the central connection defines a central opening on its top portion for attaching to the rotating shaft of a weed eater. The opening preferably extends from the top portion of the weed eater head to the bottom portion of the weed eater head. The opening also may include a recess to receive a fastener, such as a hex nut, which both secures the weed eater head on the rotating shaft and prevents the shaft from merely spinning without also spinning the weed eater head.

The weed eater head also has at least two trimmer connection portions located at the bottom portion of the weed eater head for connecting weed trimming material. The trimmer connection portions preferably define indentations in the weed eater head to receive trimmer line. In a preferred embodiment, each trimmer connection portion defines an opening in the weed eater head. In a particularly preferred embodiment, the opening extends from the top portion of the weed eater head to the bottom portion. A trimmer line attachment mechanism cooperates with each trimmer connection portion to secure the trimmer line against the bottom portion of the trimmer head. The trimmer line attachment mechanism comprises a means to secure weed trimming material quickly to each trimmer connection portion. Means can be as simple as a bolt extending through each trimmer connection opening, the bolt securing a plate to the bottom portion of the weed eater head. Trimmer line can be inserted between the plate and the bottom portion of the trimmer head. When the bolt is tightened (with a nut, wing nut or other fastener) so that the plate is drawn tightly toward the bottom portion of the trimmer head, the pressure from the plate and the bottom portion of the trimmer head securely holds the trimmer line in position. Means can also include any quick release/lock fasteners such as spring-loaded “push-to-close” fasteners or quarter-turn-to-close fasteners.

By removing the line dispenser on a standard weed eater and replacing it with the weed eater head of the present invention, a use need only insert a given length of trimmer line into each of the quick connect portions and tighten. No tools are typically required, no specific line diameter of trimming line is required, and spool removal and line winding is eliminated.

### DESCRIPTION OF THE DRAWINGS

FIG. 1 is a top perspective view of a preferred embodiment of the present invention illustrating important features of the weed trimming attachment;

FIG. 2 is a top perspective view of another preferred embodiment of the present invention illustrating important features of the weed trimming attachment; and

FIG. 3 is a bottom perspective view of the preferred embodiment shown in FIG. 2; and

FIG. 4 is a bottom view of the preferred embodiment shown in FIG. 2.

### DETAILED DESCRIPTION

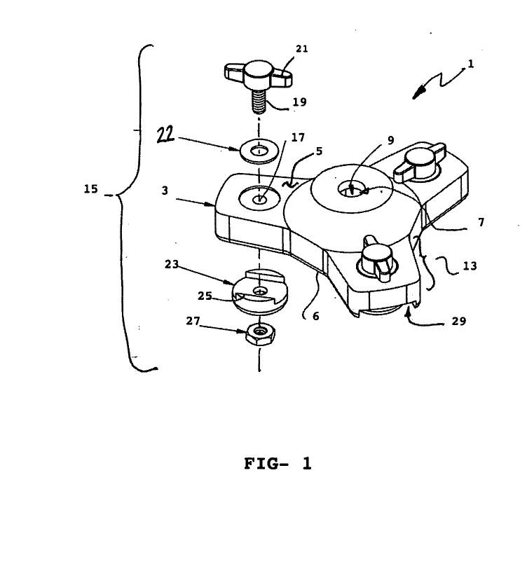

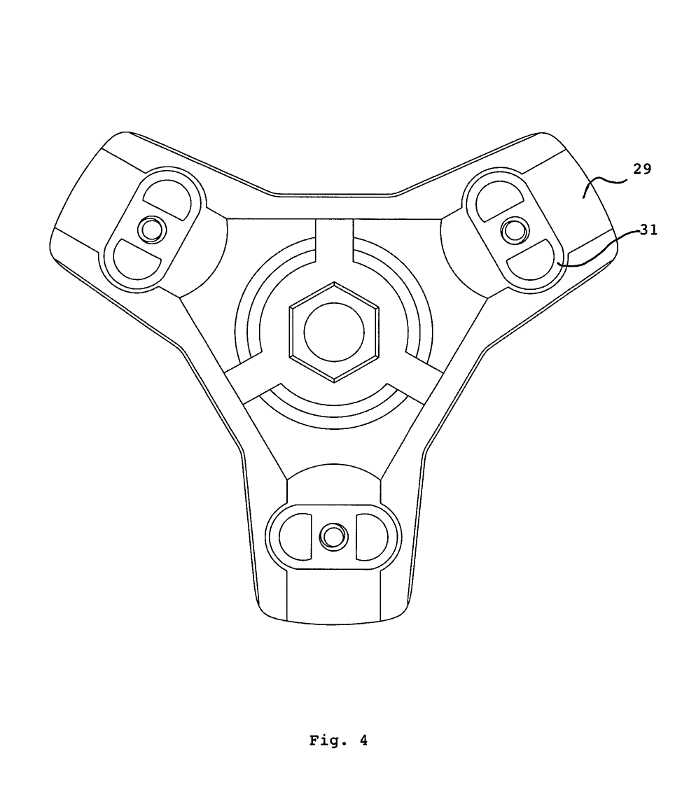

FIGS. 1-4 disclose a preferred embodiment of a new weed trimming attachment 1 for a “weed eater.” The weed trimming attachment 1 of the present invention secures to the rotating shaft of the weed eater (not shown) once the standard line dispenser (not shown) is removed. The weed trimming attachment 1 has a weed eater head 3 that has a top portion 5 and a bottom portion 6. Preferably the weed eater head is made of a single piece of molded plastic of a type that is durable enough to withstand the rigors of lawn maintenance. However, other manufacturing methods and materials may be used to produce the weed eater head 3 of the present invention. The weed eater head includes a central connection portion 7 located at the rotational center of the weed eater head 3. The central connection portion 7 may be raised slightly so that parts of the trimmer line connections (described below) do not rub against the weed eater. Preferably the central connection portion 7 defines a central opening 9 for attaching the weed eater head 3 to the rotating shaft of a weed eater. The central opening 9 preferably extends from the top portion 5 of the weed eater head 3 to the bottom portion 5 of the weed eater head 3. The central opening 9 also may include a recess 11 at the bottom portion 6 to receive a fastener, such as a hex nut, which both secures the weed eater head 3 on the rotating shaft and prevents the shaft from merely spinning without also rotating the weed eater head 3.

The weed eater head 3 also comprises at least two trimmer connection portions 13 for attaching the trimmer line to the weed eater head 3. In a preferred embodiment, the present invention 1 comprises three trimmer connection portions 13. The trimmer connection portions 13 preferably are extensions that extend radially as part of the unitary, single-piece weed eater head 3. Each trimmer connection portion 13 includes a trimmer line attachment mechanism 15 for connecting weed-trimming material. An important feature of the present invention is that the trimmer line is connected to and extends from the bottom portion of the weed eater head 3. The trimmer line attachment mechanism 15 cooperates with the trimmer connection portion 13 both to connect and to disconnect the trimmer line.

In the preferred embodiment as shown in FIGS. 1-4, each trimmer connection portion 13 defines an opening 17 in the trimmer connection portion 13. In a particularly preferred embodiment, the opening 17 extends from the top portion 5 of the weed eater head 3 to the bottom portion of the weed eater head 3. The trimmer line attachment mechanism 15 includes a bolt 19 that is inserted through the opening 17. The bolt may include a “thumb-screw” type assembly 21 at the top of the bolt 19 so that a consumer can easily tighten or loosen the bolt 21. The bolt 19 extends through the opening 17 and protrudes from the bottom portion 6 of the weed eater head 3. Washer 22 may be utilized to insure the thumb-screw does not mar the material of the weed eater head 3.

A line retention washer 23 is shown in FIG. 1 as a washer 23 having shims 25 located approximately 180 degrees apart on the washer 23 for holding the line and preventing it from dislodging from a secured position when the weed eater head 3 is rotating. The line is placed on the line retention washer 23, and the washer 23 and line are then secured to the bottom portion 6 of the weed eater head 3 with hex nut 27.

In a particularly preferred embodiment, the bottom portion 6 of the weed eater head 3 defines a recessed area 29 configured to receive the line, washer 23, bolt 19 end and hex nut 27. The recessed area 29 is preferably deep enough to help prevent the bolt 19 end and hex nut 27 from contacting the ground while the weed eater head 3 is rotating.

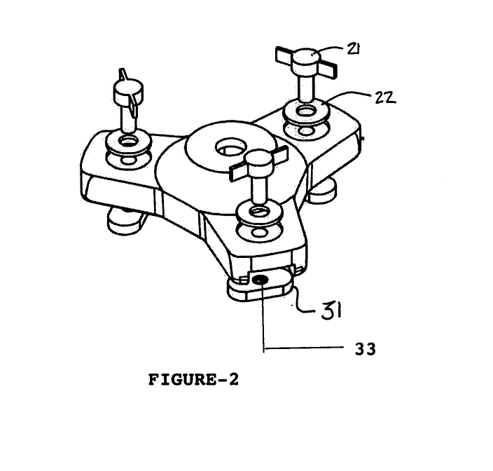

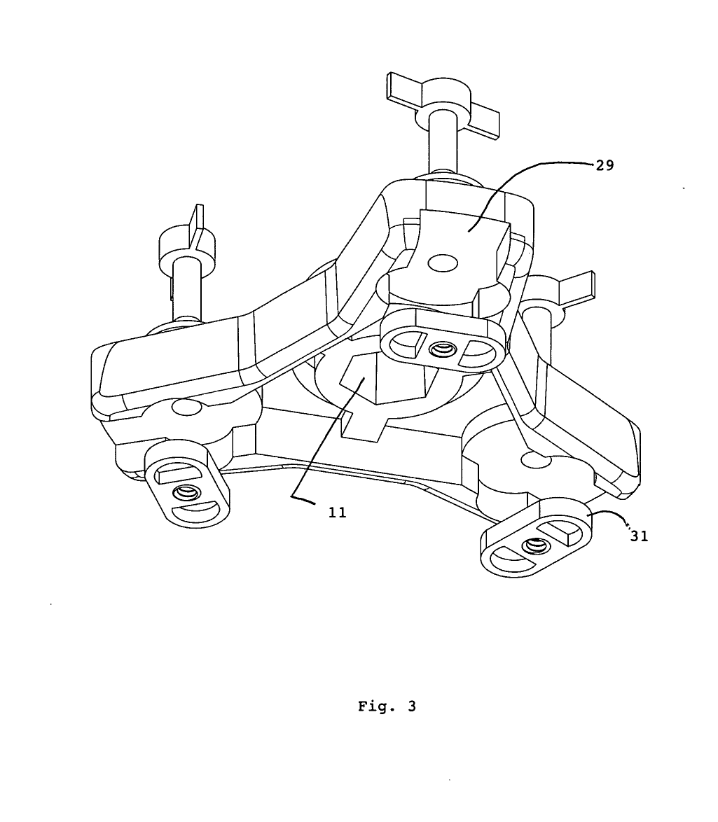

In another preferred embodiment of the present invention 1, as depicted in FIGS. 2 and 3, a securing plate 31 replaces both the washer 23 and hex nut 27. The securing plate 31 defines an opening 33 located approximately centrally in the plate 31. The opening 33 is threaded with the same thread count as the bolt 19. The recessed area 29 is configured to receive the securing plate 31. Trimmer line can be inserted between the plate 31 in the recess 29 located at the bottom portion 6 of the weed eater head 3. When the bolt 19 is tightened, the plate 31 is drawn tightly toward the bottom portion 6 of the weed eater head 3. Accordingly, the pressure on the trimmer line exerted by the plate 31 and the bottom portion 6 of the weed eater head 3 securely holds the trimmer line in position.

The means to connect the trimmer line to the bottom portion 6 of the weed eater head 3 is not limited to the means disclosed herein. The trimmer line connection mechanism can comprise any means to secure weed trimming material quickly to the bottom portion 6 of each trimmer connection portion 13. Means also can also include any quick release/lock fasteners such as spring-loaded “push-to-close” fasteners or quarter-turn-to-close fasteners.

By removing the line dispenser on a standard weed eater and replacing it with the weed eater head of the present invention, a user need only insert a given length of trimmer line of any dimension into each of the trimmer line attachment mechanisms and tighten. No tools are typically required, and spool removal and line winding is eliminated.

1. A weed trimming attachment for attaching to the rotating portion of a weed eater, the weed trimming attachment comprising:
a. A weed eater head having a top portion and a bottom portion, the weed eater head having a central connection portion located at the top portion of the weed eater head for connecting the weed eater head to the rotating portion of the weed eater, the weed eater head having at least two trimmer connection portions for connecting weed trimming material; and
b. A trimmer line attachment mechanism comprising a means to secure weed trimming material quickly to the bottom portion of the weed eater head at each trimmer connection portion.
